(19) United States
(12) Patent Application Publication
(10) Pub. No.: US 2018/0341945 A1
(43) Pub. Date: Nov. 29, 2018

(54) MULTI-LEVEL PAYOUTS USING A DISTRIBUTED LEDGER, SMART CONTRACTS, OR A COMBINATION THEREOF

(71) Applicants: John Wesley Welborn, Arlington, VA (US); Susan G. Park, Arlington, VA (US)

(72) Inventors: John Wesley Welborn, Arlington, VA (US); Susan G. Park, Arlington, VA (US)

(21) Appl. No.: 15/990,593

(22) Filed: May 26, 2018

Related U.S. Application Data
(60) Provisional application No. 62/511,661, filed on May 26, 2017.

(51) Int. Cl. G06Q 20/36; G06Q 30/02

(52) U.S. Cl. CPC G06Q 20/36; G06Q 30/0226; G06Q 30/0214

(57) ABSTRACT

A multi-level distributed ledger payouts computing system, comprising one or more computing devices programmed to: instantiate one or more operating environments for processing data structures stored in at least one computer readable storage medium having instructions stored thereon, which when executed by the at least one processor causes the multi-level payout system to: receive a request to perform a first action on a first digital wallet stored using a distributed ledger, wherein a second action to be performed on a second digital wallet stored using the distributed ledger is conditional on at least the first action; determine whether the first action meets a first condition; and when the first action meets the first condition, perform the second action on the second digital wallet.

### CROSS-REFERENCE TO RELATED APPLICATIONS

This application claims priority of earlier-filed U.S. provisional patent application No. 62/511,661, filed May 26, 2017, the contents of which are herein incorporated in their entirety.

### STATEMENT REGARDING FEDERALLY SPONSORED RESEARCH OR DEVELOPMENT

This invention was not made with federal government support.

### BACKGROUND OF THE INVENTION

The present invention relates to multi-level marketing (MLM) payouts and the like using smart contracts, a distributed ledger, or some combination of the two where payouts to at least one wallet are conditional on some action related to another wallet. MLM platforms have come under scrutiny by governmental regulatory authorities in recent years as being tantamount to pyramid schemes and the like. Thus, a need has arisen for greater transparency, auditability, security, reliability, economy, efficiency, portability, scalability and integrity of data structures and systems used to carry out MLM transactions. The present invention solves the problems associated with MLM platforms that have drawn allegations of fraud previously.

### BRIEF SUMMARY OF THE INVENTION

The invention is that of a system for improving the transparency, auditability, security, reliability, economy, efficiency, portability, scalability and integrity of MLM platforms, which have come under scrutiny in recent years as being tantamount to pyramid schemes. The system disclosed herein leverages the utility of distributed ledgers, encrypted digital wallets and blockchain technology, among other features, to ensure the integrity of data structures within multi-level marketing platforms. Transactions resulting in payouts to one or more wallets are made conditional on transactions related wallets to ensure payouts are only made when the agreed upon conditions are met within the MLM platform. This technology is capable of application outside of the MLM environment and may be useful in any environment where transactions are interdependent and require immutability of data structures to avoid fraud.

### BRIEF DESCRIPTION OF THE DRAWINGS

FIG. 1 illustrates an example of a network-based operating environment in accordance with various embodiments of the disclosure.

FIG. 2 illustrates a set of components in a multi-level payouts platform in accordance with various embodiments of the disclosure.

FIG. 3 illustrates a hierarchal diagram showing the relationship between wallets within the multi-level payouts system.

FIG. 4 is a flow diagram illustrating one exemplary embodiment of a method 400 for performing a multi-level payout to at least one wallet conditioned on some action related to another wallet.

FIG. 5 illustrates an example of a computer system with which some embodiments of the present disclosure may be utilized.

### DETAILED DESCRIPTION OF THE INVENTION

Various embodiments of the present disclosure generally relate to multi-level payouts using smart contracts, a distributed ledger, or some combination thereof where payouts to at least one wallet are conditional on some action related to another wallet. In exemplary embodiments, these general concepts are newly used in several implementations, including, but not limited to MLM organizations, referral rewards programs and loyalty rewards programs.

### Multi-Level Marketing

MLM (also called network marketing and referral marketing) is a “tree-shaped” marketing strategy where profit for an individual within the MLM can potentially be derived both from direct sales to customers and commissions based on sales from MLM members below the individual who were recruited by the individual into working for the MLM (also known as down link distributors). In exemplary embodiments, the MLMs are generally a single tree. MLM members may sell products directly to consumers by means of their relationships, and are also are incentivized to recruit others to join the MLM as they can receive commissions based on the sales of MLM members they recruit. MLM members are often not employees of the MLM and accordingly do not receive a salary or wages from the MLM. Rather, their income is derived based on profits generated in the MLM tree structure.

Recently, the MLM Industry has been beset by legal concerns stemming from allegations of fraudulent accounting and deceptive business practices. For example, in July 2016, the Federal Trade Commission (FTC) reached a settlement with Herbalife and required them to pay $200 million and mail checks to 350,000 people. The FTC has issued due diligence guidance to potential MLM consumers to enable them to better recognize pyramid schemes. Some prominent short sellers have accused certain MLM firms of being pyramid schemes. Further, the United States Court of Appeals for the Fifth Circuit recently certified a class action suit against Steam, Ignite, a residential energy MLM firm.

In addition, a number of technical problems face the MLM industry, such as, but not limited to: firms facing strong criticism for lack of transparency as to accounting and business practices (leading to allegations of fraudulent and deceptive business practices); costs associated with MLM payout processing, requiring large, custom databases which are expensive to build and maintain, either in house or by a contractor; MLM business models requiring conditional payout structures, which can be complex to model and even more difficult to modify once software and systems are developed to encode in payment algorithms; and MLM marketing requiring trust by MLM participants that payouts made are fair and accurate.

MLM organizations will often outsource database maintenance and processing activities to third-party vendors who have expertise in these areas. While this option has some benefits, to places greater control over MLM operations within the hands of vendors who are not part of the organizations themselves. Additionally, this may increase operational costs and reduce the profitability of the business.

Distributed ledger technology (DLT, also sometimes referred to as distributed digital ledger technology (DDLT) or crypto ledgers), smart contracts and various features of both can be used to provide solutions to these technical problems in the areas of: (1) greater transparency; (2) creation of improved audit trails, and auditability due to immutability of data structures produced; (3) increased security and reliability due to redundancy; (4) lowering cost; (5) reduction of complexity; (6) portability and scalability of data, systems and processing; and (7) maintaining integrity of a network even if certain wallets (nodes) dissolve or are eliminated. With reference to transparency, distributed ledgers can offer customizable levels of transparency desired by the MLM parent company and participants. These features may be of value to regulators, such as, for example, the FTC in its ongoing actions against Ponzi schemes. To that end, MLMs which use distributed ledger technology, and smart contracts could become a standard requirement for proper FTC compliance for MLM and similarly tree-structured organizations. For example, the FTC could promulgate rules that require audit trails and system auditability or the information-immutable characteristics of blockchain technology, for example, MLM payout recordkeeping. In exemplary embodiments where it would be commercially desirable and compliant to have some limits on transparency, access to the distributed ledger may be permissioned such that members of the MLM could only see the payouts or identities of members of the MLM below them in the tree structure without concomitant disclosure of those who may be positioned above them in the tree.

With reference to increased auditability and information immutability, distributed ledger records are not generally susceptible to retroactive editing once they have been created, which reduces opportunities for fraud and limits the ability for third parties to allege fraud. In exemplary embodiments, the audibility and immutability of the record can be used to demonstrate compliance to regulators or others who may raise questions. With reference to security of information and system redundancy, distributed ledger algorithms are governed by proven encryption methods that are technically and commercially superior to simple databases and passwords. Distributed ledger records are written in a manner such that the entry itself is encrypted, rather than just the database (as is more common in typical databases). With reference to cost reduction, distributed ledger technology can reduce the processing liability, and therefore costs, associated with errors, delays, and disintermediation. Use of a distributed ledger by an MLM enables new participants to enter, observe, and receive real time payouts from sales. Self-executing smart contracts can be used to reduce payout computation burden on the MLM and reduce transaction time.

With reference to complexity, distributed ledgers can reduce the complexity of the MLM payout process by collapsing the layers of intermediation between MLM parent, database, and payment processor. This is possible because distributed ledger updates can occur instantaneously, without bureaucracy or information transfer costs. With reference to portability, distributed ledgers offer consumers the ability to hold digital wallets that are independent from, and not controlled by, the MLM itself. These digital wallets can exist in a way that instantaneously processes and captures payouts through the MLM tree. Digital wallets may also be structured such that they collect payouts from multiple MLMs or sister organizations.

In exemplary embodiments, payouts in MLM to various wallets are conditional on some action by another wallet. In MLM, a person at a particular position in the tree is paid (percentage or fixed amount) based on sales of person below them. In exemplary embodiments, at least one self-executing smart contract could be used to cause each digital wallet within the tree to automatically perform payout to at least one wallet based on an event associated with at least one additional wallet.

### Referral Rewards or Loyalty Rewards Programs

Referral rewards programs (such as consumer referral rewards programs), loyalty programs (such as consumer loyalty programs), or some combination thereof can be used to provide rewards to consumers based on referrals or loyalty, for example, to a particular product, service, company, etc. In exemplary embodiments, the referral rewards programs, loyalty rewards programs, etc. can be implemented using business-to-business (B2B) transfers enabling the rewards to be transferred to another business, purchased, gifted to others (such as friends or family), etc. In exemplary embodiments, the referral rewards programs, loyalty rewards programs, etc. can provide rewards for non-monetary acts, such as for providing reviews of products, services, etc. on a website. Referral rewards programs are common in the fitness industry where a member or customer of a particular fitness club can be rewarded for referrals. Example rewards in the fitness industry could include a free class after referring a certain number of people to the class who attend the class, or a credit after referring a person that purchases a membership. Example rewards in a ridesharing service could include a credit, free ride, etc. after referring a certain number of people to the ridesharing service who then use the ridesharing service. Loyalty rewards programs may be based on purchases or patronage of a particular company. A retailer could include a referral or loyalty program that provides rewards based on referrals of potential customers who then become customers or of purchases of a customer.

A number of technical problems face rewards or loyalty programs, such as, but not limited to: (1) rewards or loyalty programs payout processing may require large, custom databases which are costly to build and maintain; and (2) rewards or loyalty programs may require conditional payout structures, which can be complex to model and even more difficult to modify once encoded in an algorithm; and (3) consumers want to trust that payouts are fair and accurate. Distributed ledger technology (DLT, also sometimes referred to as distributed digital ledger technology (DDLT)), smart-contracts, or some combination of the two can be used to provide technical solutions to these technical problems in the areas of: (1) transparency; (2) auditability and immutability; (3) security and redundancy; (4) cost; (5) complexity; (6) portability; and (7) integrity of a network even if certain wallets or nodes dissolve or are eliminated.

With reference to transparency, distributed ledgers can offer customizable levels of transparency desired by the company and consumers. In exemplary embodiments where the company would like to have some limits on the transparency, access to the distributed ledger may be permissioned such that members of the rewards programs could only see payouts or identities of customers below them in the tree and not who is above them in the tree. With reference to auditability and immutability, distributed ledger records may not be edited retroactively once they have been created, thereby reducing opportunities for fraud as well as limiting the ability for third parties to allege fraud. With reference to security and redundancy, distributed ledger algorithms are governed by proven encryption methods that are superior to simple databases and passwords. Distributed ledger records are written in a manner such that the entry itself is encrypted, rather than just the database (as is more common in typical databases). With reference to cost, distributed ledger technology can reduce the processing liability, and therefore costs, associated with errors, delays, and disintermediation. Use of a distributed ledger for referral or loyalty rewards programs gives new participants the ability to enter, observe, and receive real time rewards or loyalty bonuses. Self-executing smart contracts can be used to reduce payout computation burden on MLM and reduce transaction time.

With reference to complexity, distributed ledgers can reduce the complexity of the referral or loyalty payout process by collapsing the layers of intermediation between company, database, and payment processor. This is possible because distributed ledger updates can occur instantaneously, without bureaucracy or information transfer costs. With reference to portability, distributed ledgers offer consumers the ability to hold digital wallets that are independent from, and not controlled by, the company itself. These digital wallets can exist in a way that instantaneously processes and captures payouts through the rewards or loyalty tree. Digital wallets may also be structured such that they collect payouts from multiple companies or sister organizations. In exemplary embodiments, a consumer may have a digital wallet that is portable across multiple distributed ledgers, such as by using a single wallet address across multiple distributed ledgers.

In exemplary embodiments, referral or loyalty rewards payouts to various wallets are conditional on some action by another wallet. For example, a wallet for a person at a particular position in a tree is paid (percentage, fixed amount, credit) based on a person they referred (who is below them in the tree). In exemplary embodiments, at least one self-executing smart contract could be used to cause each digital wallet within the tree to automatically perform payout to at least one wallet based on an event associated with at least one additional wallet (such as a credit being paid to a wallet once a referral purchases a product or service). In exemplary embodiments, a referral or loyalty reward wallet is company specific. In other exemplary embodiments, a referral or loyalty reward wallet may be offered as a service for a number of different companies. In exemplary embodiments, a company's entire business model could be embedding various rewards schemes into a distributed ledger, smart contract, or a combination of the two, and then providing software support for many other companies.

In the following description, for the purposes of explanation, numerous specific details are set forth in order to provide a thorough understanding of embodiments of the present disclosure. However, upon reading the disclosure, it will be apparent to one skilled in the art that embodiments may be practiced without some of these specific details.

The techniques introduced here can be embodied as special-purpose hardware (such as circuitry), as programmable circuitry appropriately programmed with software or firmware, or as a combination of special-purpose and programmable circuitry. Hence, embodiments may include a machine-readable medium having stored thereon instructions that may be used to program a computer (or other electronic devices) to perform a process. The machine-readable medium may include, for example, floppy diskettes, optical disks, compact disc read-only memories (CD-ROMs), magneto-optical disks, read-only memories (ROMs), random access memories (RAMs), erasable programmable read-only memories (EPROMs), electrically erasable programmable read-only memories (EEPROMs), magnetic or optical cards, flash memory, or other type of media suitable for storing electronic instructions.

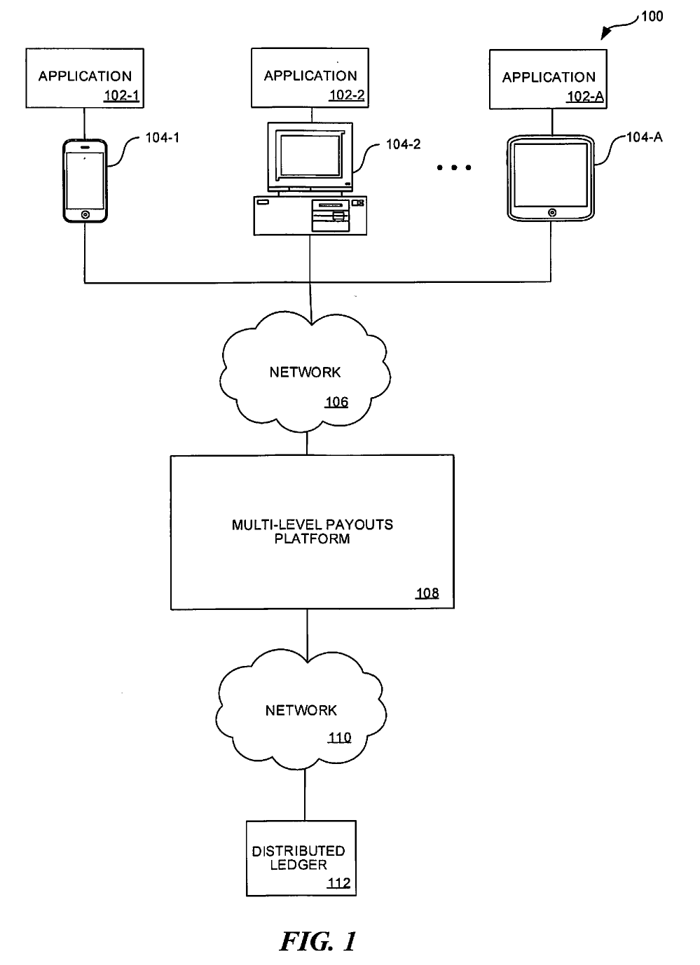

FIG. 1 illustrates an example of a network-based operating environment 100 in which some embodiments of the present disclosure may be used. As illustrated in FIG. 1, operating environment 100 includes at least one application 102 (such as application 102-1, application 102-2, and any quantity of applications 102 through application 102-A) running on at least one computing device 104 (such as mobile phone 104-1, computer 104-2, tablet computer 104-A or any other computing device such as, but not limited to, a mobile device, a mobile phone, a tablet computer, a mobile media device, a mobile gaming device, a vehicle-based computer, a dedicated terminal, a public terminal, a kiosk, or a desktop or laptop computer). In some embodiments, the at least one application 102 carries out operations such as entering and receiving transactions and checking account balances may be stored on the computing devices or may be stored remotely.

The at least one computing device 104 can include mechanisms for receiving and sending traffic by connecting through at least one network 106 to a multi-level payouts platform 108. In some embodiments, the at least one computing device 110 can retrieve and/or submit information to the multi-level payouts platform 108 and run one or more applications with customized content retrieved by the multi-level payouts platform 108. For example, the at least one computing device 110 can execute a browser application or a customized client to enable interaction between the at least one computing device 110 and the multi-level payouts platform 108. The multi-level payouts platform 108 can run on distributed systems (such as one or more servers or a plurality of computing nodes within a distributed network of computing nodes) and can be used to interface with at least one distributed ledger 112 through at least one network 110. The multi-level payouts platform 108 can create and view transactions and balances for wallets within the at least one distributed ledger 112.

The multi-level payouts platform 108 is communicably coupled with the at least one distributed ledger 112 through the at least one network 110. The at least one network 106 and the at least one network 110 can be the same network or separate networks and can be local area networks, wide area networks or combinations thereof, using any combination of wired or wireless communication systems. The at least one network 106 and the at least one network 110 could be or use any of the following protocols or technologies or combinations thereof, among others: Ethernet, IEEE 802.11 (Wi-Fi), cellular communication (such as Personal Communication Services (PCS), Advanced Wireless Services (AWS), Global System for Mobile Communications (GSM) services, Wideband Code Division Multiple Access (W-CDMA) services, Universal Mobile Telecommunications System (UMTS) services, Universal Mobile Telecommunications System Frequency-Division Duplexing (UMTS-FDD), Worldwide Interoperability for Microwave Access (WiMAX), 3rd Generation Partnership Projects (3GPP) Long Term Evolution (LTE), High Speed Packet Access (HSPA), third generation (3G) fourth generation (4G), fifth generation (5G), etc.), Code Division Multiple Access (CDMA), cable, digital subscriber line (DSL), or a combination thereof. Similarly, the networking protocols used on network 106 and network 110 may include Multiprotocol Label Switching (MPLS), Transmission Control Protocol/Internet Protocol, User Datagram Protocol (UDP), Hypertext Transfer Protocol (HTTP), Simple Mail Transfer Protocol (SMTP), and File Transfer Protocol (FTP). Data exchanged over network 106 and network 110 may be represented using technologies, “languages, and/or formats including Hypertext Markup Language (HTML) and eXtensible Markup Language (XML). In addition, all or some links can be encrypted using conventional encryption technologies such as Secure Sockets Layer (SSL), Transport Layer Security (TLS), and Internet Protocol Security (IPSec).

The at least one distributed ledger 112 records transactions between wallets that are conditional on some action by another wallet. In exemplary embodiments, the at least one distributed ledger is a blockchain. In exemplary embodiments, the distributed ledger 112 is public. In other exemplary embodiments, the distributed ledger 112 is private. When the at least one distributed ledger 112 receives a transaction signed with a proper key from the multi-level payouts platform 108 and the transaction is verified by network nodes within the at least one distributed ledger 112 and the at least one distributed ledger 112 records the transaction (such as by adding a block into a blockchain). Various data stores can be used to manage storage and access to digital wallets, user information, and other data. The data stores may be distributed data stores such as the at least one distributed ledger 112. The data stores may be a data repository of a set of integrated objects that are modeled using classes defined in database schemas. Data stores may further include flat files that can store data. The multi-level payouts platform 108 and/or other servers may collect and/or access data from the data stores.

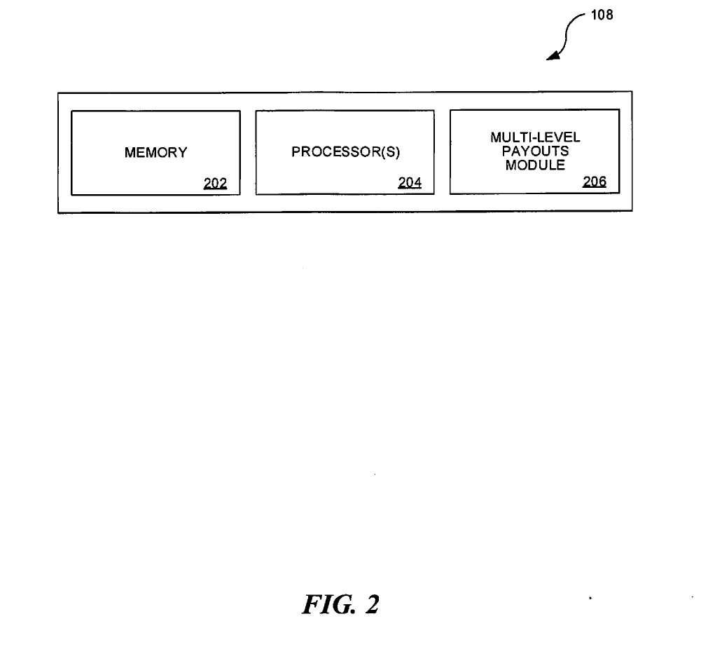

FIG. 2 illustrates a set of components within the multi-level payouts platform 108 according to one or more embodiments of the present disclosure. According to the embodiments shown in FIG. 2, the multi-level payouts platform 108 can include at least one memory 202, at least one processor 206, and at least one multi-level payouts module 206. Other embodiments may include some, all, or none of these modules and components along with other modules, applications, and/or components. Still yet, some embodiments may incorporate two or more of these modules and components into a single module and/or associate a portion of the functionality of one or more of these modules with a different module.

The at least one memory 202 can be any device, mechanism, or populated data structure used for storing information. In accordance with some embodiments of the present disclosure, the at least one memory 202 can be or include, for example, any type of volatile memory, nonvolatile memory, dynamic memory or combination thereof. For example, the at least one memory 202 can be random access memory, memory storage devices, optical memory devices, magnetic media, floppy disks, magnetic tapes, hard drives, erasable programmable read-only memories (EPROMs), electrically erasable programmable read-only memories (EEPROMs), optical media (such as compact discs, DVDs, Blu-ray Discs) or the like. In accordance with some embodiments, the at least one memory 202 may include one or more disk drives, flash drives, one or more databases, one or more tables, one or more files, local cache memories, processor cache memories, relational databases, flat databases, or the like. In addition, those of ordinary skill in the art will appreciate many additional devices and techniques for storing information which can be used as the at least one memory 202. The at least one memory 202 may be used to store instructions for running one or more applications or modules on the at least one processor 206. For example, the at least one memory 202 could be used in one or more embodiments to house all or some of the instructions needed to execute the functionality of the at least one multi-level payouts module 206.

The at least one multi-level payouts module 206 can initiate an action (such as a transaction) on at least one digital wallet stored within the at least one distributed ledger 112. In exemplary embodiments, the action is initiated upon receiving a cryptographically signed request (such as a request for a payout to a particular wallet) that is signed with a private key matching the at least one digital wallet. The action is then recorded to the at least one distributed ledger 112. Once the action is performed on the at least one digital wallet, additional actions are conditionally performed on at least one other wallet stored within the at least one distributed ledger 112. These additional actions are also stored within the at least one distributed ledger 112. In exemplary embodiments, the conditional logic is implemented using a smart contract stored within nodes of the at least one distributed ledger 112. In other embodiments, the conditional logic is implemented within the multi-level payouts module 206 or another component within the network-based operating environment 100.

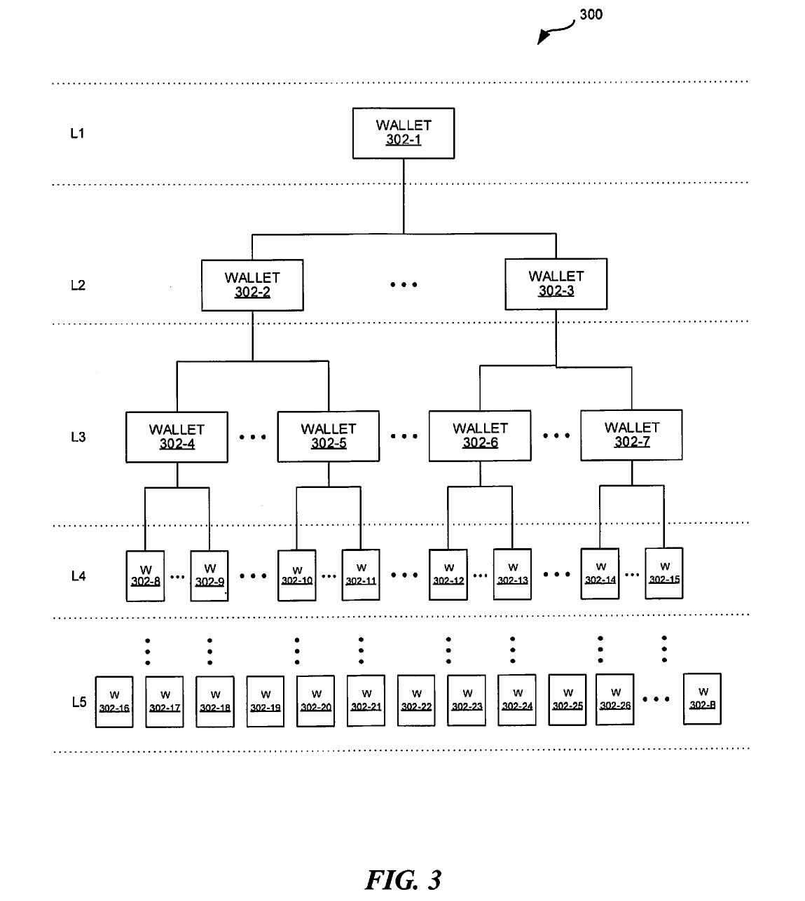

FIG. 3 illustrates a hierarchical diagram showing the relationship between wallets within the multi-level payouts tree 300. The multi-level payouts system includes a number of digital wallets 302 (such as wallet 302-1 through wallet 302-B) positioned in a tree structure having a plurality of levels (such as level L1 through level L5). In exemplary embodiments, there is a single digital wallet 302 (such as wallet 302-1) at the highest level (such as level L1), at least two digital wallets 302 (such as wallet 302-2 and wallet 302-3) at the second highest level (such as level L2), at least four digital wallets 302 (such as wallet 302-4, wallet 302-5, wallet 302-6, and wallet 302-7) at the third highest level (such as level L3), etc. It is understood that each level may have greater or fewer quantities of wallets depending on how many children each wallet at the level above has. In some embodiments, a particular wallet does not have any children that depend from it at a level below it in the multi-level payouts tree 300.

In exemplary embodiments, payouts to various wallets (such as wallet 302-1) are conditional on some action by another wallet 302 (such as wallet 302-2, wallet 302-3, wallet 302-4, etc.). The wallet 302-1 is paid (percentage, fixed amount, etc.) based on a sale associated with a wallet below them in the tree 300. In exemplary embodiments, at least one self-executing smart contract stored on nodes within the distributed ledger 112 could be used to cause automatic conditional payouts within the tree 300 to at least one wallet 302 based on an event associated with at least one additional wallet 302.

In exemplary embodiments, referral or loyalty rewards payouts to various wallets (such as wallet 302-1) are conditional on some action by another wallet 302 (such as wallet 302-2, wallet 302-3, wallet 302-4, etc.). For example, a wallet 302-1 for a person at a particular position in a tree 300 is paid (percentage, fixed amount, credit, etc.) based on an action associated with a wallet for a person they referred who is below them in the tree 300. In exemplary embodiments, at least one self-executing smart contract stored on nodes within the distributed ledger 112 could be used to cause automatic conditional payout within the tree 300 to at least one wallet 302 based on an event associated with at least one additional wallet 302. In exemplary embodiments, the event is a credit being paid to the wallet 302-1 once a wallet 302-2 associated with a referral purchases a product or service. In exemplary embodiments, a referral or loyalty reward wallet 302 is company specific. In other exemplary embodiments, a referral or loyalty reward wallet 302 may be offered as a service for a number of different companies.

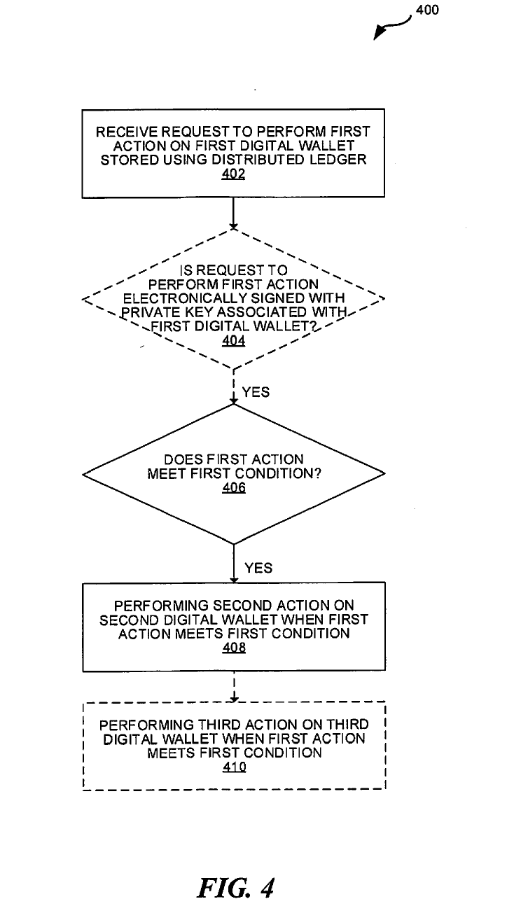

FIG. 4 is a flow diagram illustrating one exemplary embodiment of a method 400 for performing a multi-level payout to at least one wallet conditioned on some action related to another wallet. Exemplary method 400 begins at block 402 with receiving a request to perform a first action on a first digital wallet stored using a distributed ledger. A second action to be performed on a second digital wallet stored using the distributed ledger is conditional on the first action. In exemplary embodiments, the first action is a first payout to the first digital wallet. In exemplary embodiments, the second action is a second payout to the second digital wallet. In exemplary embodiments, the second payout is based on sales revenue related to the first wallet. In exemplary embodiments, the sales transactions are integrated within a sales blockchain. In exemplary embodiments, the connection to the payout blockchain could be an application programming interface (API). In other embodiments, the connection is done in other ways. In exemplary embodiments, the second payout is a percentage of the first payout. In exemplary embodiments, the second payout is a fixed amount relative to the first payout. In exemplary embodiments, the first digital wallet is associated with a first level of a tree hierarchy. In exemplary embodiments, the second digital wallet is associated with a second level of the tree hierarchy. In exemplary embodiments, the second level is above the first level within the tree hierarchy. In exemplary embodiments, the second action to be performed on the second digital wallet stored using the distributed ledger is conditional on more than the first action on the first digital wallet. For example, in exemplary embodiments, the second action may be conditional on actions or conditions of multiple other wallets or combinations of actions or conditions. For example, a percentage or fixed payout may occur if a certain number of wallets are created and there is action on the certain number of wallets (such as if five friends an individual referred buy some product, then the individual gets a certain payout and the friends also get some payout). In exemplary embodiments, there may be a payout to a second wallet and no payout to a first wallet based on a first action related to the first wallet. For example, the first action could be meeting a sales threshold related to the first wallet and the second action is a payout to the second wallet.

Exemplary method 400 proceeds to optional block 404 with determining whether the request to perform the first action is electronically signed with a private key associated with the first digital wallet. Exemplary method 400 proceeds to block 406 with determining whether the first action meets a first condition. Exemplary method 400 proceeds to block 408 with performing the second action on the second digital wallet when the first action meets the first condition. In exemplary embodiments, the conditional payouts are implemented using smart contracts stored on a plurality of nodes within the distributed ledger. Exemplary method 400 proceeds to optional block 410 with performing a third action on a third digital wallet stored using the distributed ledger when the first action meets the first condition, wherein the third action is conditional on the first action.

### Computer System Overview

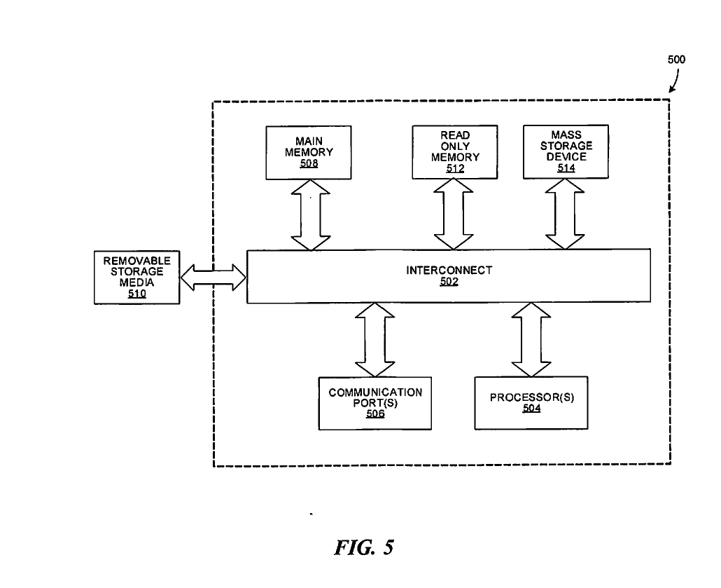

Embodiments of the present disclosure include various steps and operations, which have been described above. A variety of these steps and operations may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. As such, FIG. 5 is an example of a computer system 500 with which embodiments of the present disclosure may be utilized. According to the present example, the computer system 500 includes an interconnect 502, at least one processor 504, at least one communication port 506, at least one main memory 508, at least one removable storage media 510, at least one read only memory 512, and at least one mass storage device 514.

The at least one processor 504 can be any known processor. The at least one communication port 506 can be or include, for example, any of an RS-232 port for use with a modem-based dialup connection, a 10/100 Ethernet port, or a Gigabit port using copper or fiber. The nature of the at least one communication port 506 may be chosen depending on a network such a Local Area Network (LAN), Wide Area Network (WAN), or any network to which the computer system 500 connects. The at least one main memory 508 can be Random Access Memory (RAM), or any other dynamic storage devices commonly known in the art. Read only memory 512 can be any static storage devices such as Programmable Read Only Memory (PROM) chips for storing static information such as instructions for processors 504.

The mass storage device 514 can be used to store information and instructions. For example, hard disks such as the Adaptec® family of SCSI drives, an optical disc, an array of disks such as RAID, such as the Adaptec family of RAID drives, or any other mass storage devices may be used. Interconnect 502 can be or include one or more buses, bridges, controllers, adapters, and/or point-to-point connections. Interconnect 502 communicatively couples one or more processors 504 with the other memory, storage, and communication blocks. Interconnect 502 can be a PCI/PCI-X or SCSI based system bus depending on the storage devices used. Removable storage media 510 can be any kind of external hard-drives, floppy drives, Compact Disc-Read Only Memory (CD-ROM), Compact Disc-Re-Writable (CD-RW), Digital Video Disc-Read Only Memory (DVD-ROM).

The components described above are meant to exemplify some types of possibilities. In no way should the aforementioned examples limit the disclosure, as they are only exemplary embodiments.

### Terminology

Brief definitions of terms, abbreviations, and phrases used throughout this application are given below.

The terms “connected” or “coupled” and related terms are used in an operational sense and are not necessarily limited to a direct physical connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with this definition.

The term “responsive” includes completely or partially responsive.

The term “module” refers broadly to a software, hardware, or firmware (or any combination thereof) component. Modules are typically functional components that can generate useful data or other output using specified inputs. A module may or may not be self-contained. An application program (also called an “application”) may include one or more modules, or a module can include one or more application programs.

The term “network” generally refers to a group of interconnected devices capable of exchanging information. A network may be as few as two personal computers on a Local Area Network (LAN) or as large as the Internet, a worldwide network of computers. As used herein, “network” is intended to encompass any network capable of transmitting information from one entity to another. In some cases, a network may be comprised of multiple networks, even multiple heterogeneous networks, such as one or more border networks, voice networks, broadband networks, financial networks, service provider networks, Internet Service Provider (ISP) networks, Public or Switched Telephone Networks (PSTNs), interconnected via gateways operable to facilitate communications between and among the various networks.

Also, for the sake of illustration, various embodiments of the present disclosure have herein been described in the context of computer programs, physical components, and logical interactions within modem computer networks. Importantly, while these embodiments describe various embodiments of the present disclosure in relation to modern computer networks and programs, the method and apparatus described herein are equally applicable to other systems, devices, and networks as one skilled in the art will appreciate. As such, the illustrated applications of the embodiments of the present disclosure are not meant to be limiting, but instead are examples. Other systems, devices, and networks to which embodiments of the present disclosure are applicable include, for example, other types of communication and computer devices and systems. More specifically, embodiments are applicable to communication systems, services, and devices such as cellular networks and compatible devices. In addition, embodiments are applicable to all levels of computing from the personal computer to large network mainframes and servers.

While detailed descriptions of one or more embodiments of the disclosure have been given above, various alternatives, modifications, and equivalents will be apparent to those skilled in the art without varying from the spirit of the disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof. Therefore, the above description should not be taken as limiting.

What is claimed is:

1. A multi-level distributed ledger payout system, comprising at least one computing devices programmed to:
instantiate one or more operating environments for processing data structures stored in at least one computer readable storage medium having instructions stored thereon, which when executed by at least one computing device causes the multi-level distributed ledger payout system to:
receive a request to perform a first action on a first digital wallet stored using a distributed ledger, wherein a second action to be performed on a second digital wallet stored using the distributed ledger is conditional on at least the first action;
determine whether the first action meets a first condition; and
when the first action meets the first condition, perform the second action on the second digital wallet.

2. The system of claim 1, wherein the second action is a second payout to the second digital wallet.

3. The system of claim 2, wherein the second payout is based on sales revenue related to the first digital wallet.

4. The system of claim 1, wherein the first action is at least one of a first payout to the first digital wallet and a user associated with the first digital wallet meeting a sales goal.

5. The system of claim 1, wherein the instructions, when executed by the at least one computing device, cause the multi-level distributed ledger payout system to:
determine whether a second condition is met; and
only perform the second action on the second digital wallet when the first action meets the first condition and the second condition is met.

6. The system of claim 1, wherein the first digital wallet is associated with a first level of a tree hierarchy, wherein the second digital wallet is associated with a second level of the tree hierarchy, wherein the second level is above the first level within the tree hierarchy.

7. The system of claim 6, wherein the tree hierarchy represents at least one of a multi-level marketing organization, a referral rewards program, and a loyalty rewards program.

8. The system of claim 1, wherein the conditional first and second actions are implemented using smart contracts stored on a plurality of nodes within the distributed ledger.

9. The system of claim 1, wherein the at least one computer readable storage medium having instructions stored thereon, when executed by the at least one computing device, further causes the multi-level distributed ledger payout system to:
determine whether the request to perform the first action is electronically signed with a private key associated with the first digital wallet.

10. The system of claim 1, wherein the at least one computer readable storage medium having instructions, when executed by the at least one processor, further causes the multi-level payout system to:
when the first action meets the first condition, perform a third action on a third digital wallet stored using a distributed ledger, wherein the third action is conditional on the first action.

11. The system of claim 1, further comprising a third digital wallet, wherein the first digital wallet is associated with a first level of a tree hierarchy;
wherein the second digital wallet is associated with a second level of the tree hierarchy;
wherein the third digital wallet is associated with a third level of the tree hierarchy;
wherein the second level is above the first level within the tree hierarchy; and
wherein the third level is above the second level within the tree hierarchy.

12. The system of claim 11, wherein the tree hierarchy represents at least one of a multi-level marketing organization, a referral rewards program, and a loyalty rewards program.

13. A method of conditional payouts within digital wallets stored using a distributed ledger computing system, the method comprising:
receiving a request to perform a first action on a first digital wallet stored using a distributed ledger computing system, wherein a second action to be performed on a second digital wallet stored using the distributed ledger computing system is conditional on at least the first action;
determining on the computing system whether the first action meets a first condition; and
when the first action meets the first condition, performing on the computing system the second action on the second digital wallet.

14. The method of claim 13, wherein the second action is a second payout to the second digital wallet.

15. The method of claim 14, wherein the second payout is based on sales revenue related to the first digital wallet.

16. The method of claim 13, wherein the first action is at least one of a first payout to the first digital wallet and a user associated with the first digital wallet meeting a sales goal.

17. The method of claim 13, further comprising:
determining whether a second condition is met; and
only performing the second action on the second digital wallet when the first action meets the first condition and the second condition is met.

18. The method of claim 13, wherein the first digital wallet is associated with a first level of a tree hierarchy;
wherein the second digital wallet is associated with a second level of the tree hierarchy; and
wherein the second level is above the first level within the tree hierarchy.

19. The method of claim 18, wherein the tree hierarchy represents at least one of a multi-level marketing organization, a referral rewards program, and a loyalty rewards program.

20. The method of claim 13, wherein the conditional payouts are implemented using smart contracts stored on a plurality of nodes within the distributed ledger.

21. The method of claim 13, further comprising:
determining whether the request to perform the first action is electronically signed with a private key associated with the first digital wallet.

22. The method of claim 13, further comprising:
when the first action meets the first condition, performing a third action on a third digital wallet stored using the distributed ledger, wherein the third action is conditional on the first action.

23. The method of claim 13, further comprising a third digital wallet, wherein the first digital wallet is associated with a first level of a tree hierarchy;
wherein the second digital wallet is associated with a second level of the tree hierarchy;
wherein the third digital wallet is associated with a third level of the tree hierarchy;
wherein the second level is above the first level within the tree hierarchy; and
wherein the third level is above the second level within the tree hierarchy.

24. The method of claim 23, wherein the tree hierarchy represents at least one of a multi-level marketing organization, a referral rewards program, and a loyalty rewards program.
